(19) United States
(12) Patent Application Publication
(10) Pub. No.: US 2014/0281034 A1
(43) Pub. Date: Sep. 18, 2014

(54) System and Method for Compressing Data Associated with a Buffer

(71) Applicant: FUTUREWEI TECHNOLOGIES, INC., Plano, TX (US)

(72) Inventor: Aaron Callard, Ottawa (CA)

(21) Appl. No.: 13/801,055

(22) Filed: Mar. 13, 2013

(51) Int. Cl. H04L 29/06

(52) U.S. Cl. CPC H04L 29/0604
USPC 709/247

(57) ABSTRACT

System and method embodiments are provided for compressing data associated with a buffer while keeping delay in data forwarding beyond within about the buffer time. AN embodiment method includes receiving, at a data compression node, data packets from a previous node on a forwarding path for the data packets, compressing the data packets using a compression scheme according to a feedback from buffering the data packets at a buffering node subsequent to the compression node on the forwarding path, and sending the compressed data packets to the buffering node. Another method includes sending, from a buffering node, feedback of buffered data at the buffering node, receiving, from a data compression node, data packets compressed using a compression scheme according to a feedback from buffering the data packets at the buffering node, and transmitting the data packets from the buffering node after a delay time according to the feedback.

### TECHNICAL FIELD

The present invention relates to network data compression, and, in particular embodiments, to a system and method for compressing data associated with a buffer.

### BACKGROUND

Communication networks transfer data, which may include compressed data in compressed formats or files. Typically, the data is compressed at the source, for example by a software (or hardware) data compressing scheme before transferring the data through the network to some destination. The data is compressed to reduce its size, for instance to save storage size or reduce network traffic load. Data compression schemes may also be designed to increase data throughput, e.g., the amount of transmitted data over a time period or unit. A network that transfers compressed data may include one or more buffers along the data transfer path. Buffer delays and hence network delays, for example at network bottlenecks between high rate links and low rate links, can be caused by the processing time at the nodes on the path and/or the amount or size of data being buffered. Since processing time and buffer time can affect network delays, there is a need for an improved scheme of compressing data associated with a buffer to reduce network delays and/or improve throughput.

### SUMMARY OF THE INVENTION

In accordance with an embodiment, a method for compressing data associated with a buffer includes receiving, at a data compression node, data packets from a previous node on a forwarding path for the data packets, compressing the data packets using a compression scheme according to a feedback from buffering the data packets at a buffering node subsequent to the compression node on the forwarding path, and sending the compressed data packets to the buffering node.

In accordance with another embodiment, a network component for compressing data associated with a buffer includes a processor and a computer readable storage medium storing programming for execution by the processor. The programming includes instructions to receive data packets from a previous node on a forwarding path for the data packets, compress the data packets using a compression scheme according to a feedback from buffering the data packets at a buffering node subsequent to the network component on the forwarding path, and send the compressed data packets to the buffering node.

In accordance with another embodiment, a method for supporting compression of data associated with a buffer includes sending, from a buffering node, feedback of buffered data at the buffering node, receiving, from a data compression node, data packets compressed using a compression scheme according to a feedback from buffering the data packets at the buffering node, and transmitting the data packets from the buffering node after a delay time according to the feedback.

In accordance with another embodiment, a network component for supporting compression of data associated with a buffer includes a buffer configured to queue data packets, a processor, and a computer readable storage medium storing programming for execution by the processor. The programming including instructions to send feedback of buffered data in the buffer, receive, from a data compression node, data packets compressed using a compression scheme according to a feedback from buffering the data packets in the buffer, and transmit the data packets after a delay time according to the feedback.

In accordance with another embodiment, a method for supporting compression of data associated with a buffer includes receiving, from a buffering node, feedback of buffered data at the buffering node, determining a compression scheme for data packets according to the feedback, and sending the compression scheme to a compression node that precedes the buffering node on a forwarding path for the data packets.

In accordance with yet another embodiment, a network component for supporting compression of data associated with a buffer includes a processor and a computer readable storage medium storing programming for execution by the processor. The programming including instructions to receive, from a buffering node, feedback of buffered data at the buffering node, determine a compression scheme for data packets according to the feedback, and send the compression scheme to a compression node that precedes the buffering node on a forwarding path for the data packets.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 is a typical data transfer and buffering scheme in a wireless networking system;

FIG. 2 is an embodiment of a data compression and buffering scheme in a wireless networking system;

FIG. 3 is an embodiment of a method for compressing data associated with a buffer;

FIG. 4 is a processing system that can be used to implement various embodiments.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

Applying compression to data takes processing time, but does not necessarily add to packet delay. For example, in a network router that includes a non-empty buffer, a packet can take a number of time units (e.g., milliseconds) to pass through the buffer, e.g., depending on the buffer size and/or the data size in the buffer. If the processing time is less than this time, then the packet may not experience extra delay beyond the buffer time. For example, if a compression algorithm is applied to a packet in the buffer without affecting the packet position or order and needs a packet processing time less that the packet buffer time, then the packet may not experience addition delay beyond the packet buffer time. This may also hold for multiple routers (or nodes) including corresponding buffers and located over multiple hops or links along a packet forwarding path. If the total processing time for compressing the packets in all the nodes is less than the total buffer time in all the buffers along the path and if the packets processing does not affect the order of packets in the buffers, then the packets may not experience additional delay across the path beyond the total buffer time.

System and method embodiments are provided for compressing data associated with a buffer without increasing (or without significantly increasing) delay in data forwarding beyond the buffer time. The system and method include processing data for compression considering information about buffering time to ensure that the processing or compression time does not exceed the buffer delay time, and thus does not introduce additional delay to data forwarding from the buffer. The data is processed (for compression) at a processing node preceding the buffering node without impacting the order or position of the data with respect to the buffer. To ensure the proper ordering of the data in the buffer, a timestamp can be added to the data packets before sending the compressed data from the processing node to the buffering node. For example, if data packets were out of order due to processing delays at the processing node, the data received at the buffering node can be rearranged using their timestamps to the original order in which they were received. The amount of data compressed is determined such that the processing time remains less than or about equal to the buffer time.

A compression rate can be determined for compressing the data at the processing node according to the buffer information at the buffering node. The compression rate may be determined at a controller or processor at the processing node, the buffering node, or a third node that receives information from the buffering node and forwards the compression rate to the processing node. Further, the timestamp can be added to the data at the processing node (upon arrival of the data) or by a node preceding the processing node on the data forwarding path.

This compression scheme can be implemented in any suitable type of network where a node along the data forwarding path includes a data buffer and transfers compressed data. However, the buffering node itself is not designed to or does not have the capacity to compress data. Instead, the buffering node is configured to receive and buffer the compressed data before sending the compressed data to the next hop. For example, the buffering node may be at a bottleneck of the network between high rate links and low rate links or handling forwarding between significantly more ingress nodes than egress ports. Such nodes may not be suitable for performing heavier processing functions, such as data compression. Therefore, a processing node preceding the buffering node implements data compression (before forwarding the data to the buffer node after compression) using a scheme that maintains the order of the received data in the buffering node and does not add delays beyond the buffer time.

In an embodiment, this scheme is implemented in a wireless networking system, where data are forwarded from an edge or access node, such as a gateway, to a base station (BS) or radio node for wireless transmission. FIG. 1 is a typical data transfer and buffering scheme 100 in a wireless networking system. The wireless networking system includes a gateway (GW) 120 coupled to a BS 130 (e.g., an Evolved Node B), which may be part of a cellular network. The GW 120 may also be coupled to a source node 110, for example in a core or backbone network or via one or more networks. The BS 130 is also coupled to a sink node 140, e.g., in the cellular network. The GW 120 is configured to allow the BS 130 access to the core, backbone, or other network, such as a service provider network. The BS 130 is configured to allow the sink node 140 to communicate wirelessly with the network. The BS 130 includes a buffer 102 for buffering or queuing received data before forwarding on the data, e.g., from the GW 120 to the sink node 140. The source node 110 is any node that originates data and the sink node 140 is any user or customer node, for example a mobile or wireless communication/computing device.

Typically, when the BS 130 receives compressed data, the data is previously compressed at the source node 110. Further, the buffer 102 is placed at the BS 130 instead of the GW 120 because the connection between the GW and the BS can be significantly faster (e.g., has higher bandwidth) than the connection between the BS 130 and the sink node 140. In the scheme 100, when the buffer 102 is empty, any processing at the GW 120 may add to the overall packet forwarding delay along the path or flow to the sink node 140. In the case of multiple data flows from the GW 120 to the BS 130, flows with less processing time have less delay than flows with more processing time.

FIG. 2 shows an embodiment of a data compression and buffering scheme 200 in a wireless networking system. The wireless networking system includes a source node 210, a GW 220, a BS 230 including a buffer 202, and a sink node 240. The source node 210 and the sink node 240 are configured similar to the source node 210 and the sink node 240, respectively. The scheme 200 allows packet compression along the forwarding path between the source node 210 and the sink node 240 without adding delays caused by the processing time. The data may be compressed to reduce traffic load and/or increase throughput, and hence improve overall system performance and quality of service.

The scheme 200 includes feeding back queue status or information from the BS 230 to the GW 220. The term queue and buffer may be used herein interchangeably. The queue status may include buffer or queue delay statistics or information, such as average delay time, minimum delay time, delay variance, buffer size, queued data size, or other buffer related information. Upon receiving data or packets from the source node 210, the GW 220 adds a timestamp to each packet and performs compression on the data, if needed or requested, based on the queue status or information such that the increase in end-to-end (or overall) delay is minimized. After processing, the GW 220 forwards the packets, including the timestamps, to the BS 230 (e.g., without further queuing in the buffer 201). Packets that take longer processing time are sent to the BS 230 after subsequently received packets that take less or no processing time. This may cause a change in the original transmission order of the packets. To ensure that the packets are arranged according to their original order, the BS 230 schedules or queue the packets from the GW 220 according to the timestamps of the packets. This guarantees that the BS 230 puts the received packets in the buffer 202 in the order in which the packets would have been received if compression (at the GW 220) took no time. Further, the packets are processed at the GW 220 (e.g., in a buffer 201) within a processing time that does not exceed the expected buffering time at the BS 230 (in the buffer 202).

Using the queue status feedback from the BS 230, the GW 220 determines how much time can be spent on processing the packets without impacting the overall delay and hence performance of the system. The queue status can indicate the expected delay of individual packets at the BS 230 (in the buffer 202) before transmission. Different status information can be sent from the BS 230 to indicate this expected delay. Each considered flow (e.g., for each user or quality of service class indicator (QCI)) at the BS 230 may have associated statistics that can be used to provide this information. For instance, the queue status information that can be used to determine the expected delay include minimum delay of packet over a determined time window, average delay of packet over a determined time window, buffer size, average data rate, other buffer or data information or statistics, or combinations thereof.

Optionally, the feedback from the BS 230 may also include delay tolerance or acceptable delay for different flows or streams. This allows the BS 230 to increase the delay of one stream in order to reduce delays of other streams. For example, if two streams have equal importance or priority and only one of the streams can be compressed, the BS 230 can send back to the GW 220 a delay tolerance for both streams that allows the compressor at the GW 220 to increase the delay of the compressible stream. Another option is for the BS 230 to send back to the GW 220 the expected delay if the packets are not processed for compression. This may help prevent oscillations as compression is turned on or off. The feedback from the BS 230 may also include the spectral efficiency, interference, and/or acceptable compression rate vs. a delay exchange rate. As such, the compressor at the GW 220 can determine the optimal delay allowed for compressing the data. Outer loop variables may also be applied to value mismatch between approximations and actual use, e.g., to ensure that buffer under runs (times where buffer is significantly under occupied) at the BS 230 are minimized or reduced.

In the timestamp process at the GW 220, information is added to the received packets (e.g., from the source node 210) to ensure that the original ordering of the packets can be achieved subsequently at the BS 230 (in the buffer 202). This can be achieved in different ways. For instance, a timestamp indicating the arrival time of the packet at the GW 220 can be sent with every packet to the BS 230. Alternatively, a timestamp can be sent as a separate packet (from a group of data packets). Upon receiving this timestamp packet, the BS 230 may apply this value (or a function of the value) to all following data packets received subsequently, e.g., until another timestamp packet is received.

The timestamp information may include an absolute value representing some agreed upon clock time that indicates the packet arrival time, a delay value representing how long the packet was delayed, a difference of delay or other compressed delay format, or an index of packets. The index can be used to determine the relative delay within different streams/packets. Relative delay information may only achieve reordering of data coming from a single GW 220. If multiple GW 220 are sending packets to the BS 230, then relative delays are not sufficient to reorder the data from the different GWs 220 at the same BS 230, since some of the data may have the same relative delay information.

In one implementation, the data can be reordered at the BS 230 using, in addition to a timestamp, the buffer status/size of the GW 220 depending on how the packet scheduling/resource allocation is implemented. For instance, for delay based scheduling, a timestamp is sufficient. However, for queue based scheduling, the effective queue length at the GW 220 is also taken into account when ordering the data packets at the BS 230 to prioritize the packets. One formula that can be used to this end is the delay of the packet multiplied by a predicted rate of the traffic. The size of the buffer 201 size at the GW 220 can be sent explicitly to the BS 230 for this purpose.

To compress the data, the compressor at the GW 220 may choose a compression scheme which reduces the overall delay and improves the overall performance. Different schemes can be used by the GW 220 regarding which level of compression to perform, and consequently what delay to add. In one scheme, referred to herein as a ‘No Harm’ scheme, the compression level is chosen so that the delay of an individual packet is not increased. This scheme uses a compression rate (CR) which has a delay less than the current packet delay at the BS 230. This scheme formula may be represented as:

CR used=max(CR)s.t. delay<delay_{CR},

where delay is the head of queue packet delay at the BS 230 (at the buffer 202), and delay_{CR} is the compression rate delay. The delay_{CR} is a statistical value, which can be converted to a single number using suitable functions. Alternatively, more advanced schemes or functions can be used to ensure that the maximum delay is less than a determined amount of delay, e.g., taking into account the statistical nature of the various links.

The ‘No Harm’ scheme steady state may cause large buffer sizes. To avoid such situation, a second scheme, referred to herein as a ‘Proportional Integral’ (PI) scheme, is used. In this scheme, an integral of the difference from target delay is maintained and added to the individual packet delay. The compression rate is chosen such that the sum of the integrated delay and packet delay are less than the compression delay. This scheme algorithm can be represented as:
if delay>threshold
   integral+=step;
else
   integral−=step;
   delay_effective=integral+delay.

After processing the packets for compression at the GW 220, the packets are sent to the BS 230 in a normal manner. In some scenarios, one or more routers that may be positioned between the GW 220 and the BS 230 can read the timestamps in the packets for packet scheduling purposes.

The BS 230 receives the packets from the GW 220, which may include compressed data, and uses the timestamp(s) to schedule the packets' arrival time. Different schemes can be used to factor in the delay of the packets (the size of the buffer at the GW 220) into the scheduling at the BS 230, for instance depending on how the packet scheduler at the BS 230 is implemented. For delay based scheduling, the additional delay is calculated using the timestamp associated with the packet. In some scenarios, additional controllers can be used to ignore this value. For queue length scheduling, the effective buffer size at the GW 220 can also be used (in addition to the timestamp) to calculate the delay, as described above.

In another embodiment method for processing (or compressing) data packets at the GW 220 and subsequently ordering the packets properly at the BS 230, the compressor at the GW 220 initially forwards the received packets as received without compression to the BS 230. The compressor also works on compressing the packets, e.g., at about the same time or in parallel to sending the uncompressed packets to the BS 230. When a packet is compressed at the GW 220, the compressed version is forwarded on to the BS 230. When the compressed packet arrives at the BS 230, the previously received uncompressed version is replaced with the compressed version. The compressed version can then be forwarded down the path (e.g., to the sink node 240).

The embodiments above can be extended to multiple users, e.g., multiple sink nodes 240 communicating with the BS 230. In some scenarios, it may not be possible to compress data for every user or the queue status from the BS 230 does not indicate or specify when to compress data for different users. For instance, if one node is overloaded (e.g., a sink node 240), then neighboring nodes can request compression and therefore reduce interference. This can be implemented by applying an adaptive scheduling scheme to reduce the data rate of the users, and hence increase the delay/buffer size.

In some scenarios, there may be enough processing power (at the GW 220) to apply compression on a fraction of the data only. In this case, compression can be applied to improve the overall conditions and performance of the system. For example, two users with guaranteed bit rate (GBR) traffic can have equal delay but different spectral efficiencies. In this case, data compression may be applied to the user with the lower spectral efficiency. Different aspects or parameters can be taken into account to decide which user's data to compress. For instance, the decision parameters can include spectral efficiency, load of a cell of users, impact of serving a user on other cells' spectral efficiency/load, traffic type/priority (e.g., guaranteed bit rate, best effort, etc.), or combinations thereof.

One method that can be used for packet prioritization for multiple users is to calculate a utility function taking each of the parameters above into account. The goal may be to compress (as much as possible) the scheduled data in overloaded cells. This can be achieved by looking at the delay and the spectral efficiency. The delay acts as an indicator of load in the cells and the spectral efficiency indicates the impact of applying compression. Accordingly, the priority of a packet can be evaluated as

$$\frac{f ( d , {d}_{th} )}{spectral efficiency} ,$$

where f(d,dth) is the priority given in scheduling for a packet delay with deadline dₜₕ. For best effort traffic, f(d,dth) can be an increasing step function. The weighting factor

$$\frac{1}{spectral efficiency} ,$$

is used to differentiate between loaded and unloaded cells.

FIG. 3 shows an embodiment of a method 300 for compressing data associated with a buffer. The method 300 can be implemented as part of the scheme 200 to allow data processing capability in the networking system without causing any or significant additional delays to the packets, e.g., beyond the buffer delay time at the BS 230. At step 310, queues status is received from a buffering node at a processing node. For example, the BS 230 sends its queues status or associated information to the GW 220 that performs the processing and compression. At step 320, one or more packets are received at the processing node. For example, the packets are received in the buffer 201 at the GW 220. At step 330, a timestamp is added to each or a group of packets at the processing node. The timestamp can be added, at the GW 220, within a received data packet or a separate packet. At step 340, the one or more received packets are compressed at the processing node, e.g., in the buffer 201 of the GW 220. At step 350, the one or more packets are sent with the corresponding timestamp(s) from the processing node to the buffering node, e.g., to the BS 230. At step 360, the one or more packets are received, at the buffering node, and scheduled or ordered in the buffer using the timestamp(s) associated with the packet(s). For example, the packet(s) are received and scheduled in the buffer 202 at the BS 230.

Although the method 300, the scheme 200, and other schemes above are described in context of a wireless networking system, the schemes above can be implemented in other networking systems that include a buffering node and a processing node preceding the buffering node on a data forwarding path. The schemes can also be extended to multiple buffering and processing nodes along a forwarding path.

FIG. 4 is a block diagram of a processing system 400 that can be used to implement various embodiments. Specific devices may utilize all of the components shown, or only a subset of the components, and levels of integration may vary from device to device. Furthermore, a device may contain multiple instances of a component, such as multiple processing units, processors, memories, transmitters, receivers, etc. The processing system 400 may comprise a processing unit 401 equipped with one or more input/output devices, such as a network interfaces, storage interfaces, and the like. The processing unit 401 may include a central processing unit (CPU) 410, a memory 420, a mass storage device 430, and an I/O interface 460 connected to a bus. The bus may be one or more of any type of several bus architectures including a memory bus or memory controller, a peripheral bus or the like.

The CPU 410 may comprise any type of electronic data processor. The memory 420 may comprise any type of system memory such as static random access memory (SRAM), dynamic random access memory (DRAM), synchronous DRAM (SDRAM), read-only memory (ROM), a combination thereof, or the like. In an embodiment, the memory 420 may include ROM for use at boot-up, and DRAM for program and data storage for use while executing programs. In embodiments, the memory 420 is non-transitory. The mass storage device 430 may comprise any type of storage device configured to store data, programs, and other information and to make the data, programs, and other information accessible via the bus. The mass storage device 430 may comprise, for example, one or more of a solid state drive, hard disk drive, a magnetic disk drive, an optical disk drive, or the like.

The processing unit 401 also includes one or more network interfaces 450, which may comprise wired links, such as an Ethernet cable or the like, and/or wireless links to access nodes or one or more networks 480. The network interface 450 allows the processing unit 401 to communicate with remote units via the networks 480. For example, the network interface 450 may provide wireless communication via one or more transmitters/transmit antennas and one or more receivers/receive antennas. In an embodiment, the processing unit 401 is coupled to a local-area network or a wide-area network for data processing and communications with remote devices, such as other processing units, the Internet, remote storage facilities, or the like.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method for compressing data associated with a buffer, the method comprising:
receiving, at a data compression node, data packets from a previous node on a forwarding path for the data packets;
compressing the data packets using a compression scheme according to a feedback from buffering the data packets at a buffering node subsequent to the compression node on the forwarding path; and
sending the compressed data packets to the buffering node.

2. The method of claim 1 further comprising:
receiving, from the previous node, a timestamp for one or more of the data packets; and
sending the timestamp with the data packets to the buffering node.

3. The method of claim 2, wherein the timestamp indicates an absolute arrival time or index of the data packets.

4. The method of claim 2, wherein the timestamp indicates a delay time or a difference of delay time for the data packets.

5. The method of claim 2, wherein a timestamp is indicated in each of the data packets.

6. The method of claim 2, wherein a timestamp is indicated in a separate packet for each group of the data packets.

7. The method of claim 1 further comprising sending buffer status or size information of the data compression node to the buffering node to enable queue based scheduling for the data packets at the buffering node.

8. The method of claim 1 further comprising:
receiving feedback of buffered data at the buffering node; and
determining the compression scheme according to the feedback.

9. The method of claim 8, wherein the data compression node receives feedback of buffered data for each user that communicates with the buffering node, determines for each user, according to the feedback for the user, a delay time for buffering data packets for the user at the buffering node, and compresses the data packets for each user during a compression time less than or about equal to the delay time for the user.

10. The method of claim 9, wherein the feedback of buffered data for each user includes at least one of spectral efficiency, interference information, and acceptable compression rate versus delay exchange rate, and wherein the data compression node determines for each user, according to the feedback of the user, an optimal compression time for compressing the data packets for each user.

11. The method of claim 9, wherein the feedback of buffered data for each user include at least one of spectral efficiency, interference information, and acceptable compression rate versus delay exchange rate, and wherein the data compression node determines whether to compress the data packets for each user according to the feedback for the user.

12. The method of claim 8, wherein the feedback includes at least one of a minimum delay of data packets over a determined time window, an average delay of data packets over a determined time window, a size of a buffer at the buffering node, and an average data rate at the buffering node.

13. The method of claim 8, wherein the compression node receives the feedback from the buffering node, a controller node, or a network.

14. The method of claim 1 further comprising receiving the compression scheme from the buffering node, a controller node, or a network.

15. A network component for compressing data associated with a buffer, the network component comprising:
a processor; and
a computer readable storage medium storing programming for execution by the processor, the programming including instructions to:
receive data packets from a previous node on a forwarding path for the data packets;
compress the data packets using a compression scheme according to a feedback from buffering the data packets at a buffering node subsequent to the network component on the forwarding path; and
send the compressed data packets to the buffering node.

16. The network component of claim 15, wherein the programming further includes instructions to:
add a timestamp for one or more of the data packets; and
send the timestamp with the data packets to the buffering node.

17. The network component of claim 15, wherein the programming further includes information to:
receive, from the buffering node or a controller node coupled to the buffering node, feedback of buffered data at the buffering node; and
determine the compression scheme according to the feedback.

18. The network component of claim 15, wherein the programming further includes information to receive the compression scheme from the buffering node or a controller node coupled to the buffering node.

19. The network component of claim 15, wherein the buffering node is a base station (BS) coupled to the network component and to a destination node for the data packets, and wherein the network component is a gateway of a wireless or cellular network.

20. A method for supporting compression of data associated with a buffer, the method comprising:
sending, from a buffering node, feedback of buffered data at the buffering node;
receiving, from a data compression node, data packets compressed using a compression scheme according to a feedback from buffering the data packets at the buffering node; and
transmitting the data packets from the buffering node after a delay time according to the feedback.

21. The method of claim 20 further comprising:
receiving, with the data packets, timestamps that indicate arrival time of the data packets prior to or at the compression node on a path for forwarding the data packets; and
scheduling the data packets at the buffering node according to the timestamps.

22. The method of claim 21 further comprising:
receiving, at the buffering node, buffer status or size information of the data compression node; and
scheduling the data packets using queue based scheduling according to the timestamps and buffer status or size information of the data compression node.

23. The method of claim 21, wherein the buffering node sends, to the data compression node or a controller node coupled to the data compression node, feedback of buffered data for each user that communicates with the buffering node, receives with the data packets for each user timestamps that indicate arrival time of the data packets of the user, and schedules the data packets for each user at the buffering node according to the timestamps.

24. The method of claim 20 further comprising sending, from the buffering node, the compression scheme to the compression node.

25. The method of claim 20 further comprising prioritizing the data packets in a buffer of the buffering node according to an effective buffer size of the data compression node.

26. A network component for supporting compression of data associated with a buffer, the network component comprising:
a buffer configured to queue data packets;
a processor; and
a computer readable storage medium storing programming for execution by the processor, the programming including instructions to:
send feedback of buffered data in the buffer;
receive, from a data compression node, data packets compressed using a compression scheme according to a feedback from buffering the data packets in the buffer; and
transmit the data packets after a delay time according to the feedback.

27. The network component of claim 26, wherein the programming includes further information to:
receive, with the data packets, timestamps that indicate arrival time of the data packets prior to or at the compression node on a path for forwarding the data packets; and
schedule the data packets according to the timestamps.

28. A method for supporting compression of data associated with a buffer, the method comprising:
receiving, from a buffering node, feedback of buffered data at the buffering node;
determining a compression scheme for data packets according to the feedback; and
sending the compression scheme to a compression node that precedes the buffering node on a forwarding path for the data packets.

29. A network component for supporting compression of data associated with a buffer, the network component comprising:
a processor; and
a computer readable storage medium storing programming for execution by the processor, the programming including instructions to:
receive, from a buffering node, feedback of buffered data at the buffering node;
determine a compression scheme for data packets according to the feedback; and
send the compression scheme to a compression node that precedes the buffering node on a forwarding path for the data packets.
